(19) United States
(12) Patent Application Publication
(10) Pub. No.: US 2016/0119709 A1
(43) Pub. Date: Apr. 28, 2016

(54) SOUND REPRODUCTION SYSTEM WITH A TACTILE INTERFACE FOR EQUALIZATION SELECTION AND SETTING

(71) Applicant: PARROT, Paris (FR)

(72) Inventors: Pierre Beurton, Paris (FR); Frederic Lhuillery, Paris (FR)

(21) Appl. No.: 14/871,101

(22) Filed: Sep. 30, 2015

(30) Foreign Application Priority Data
Oct. 28, 2014 (FR) 1460350

(51) Int. Cl. H04R 1/10; G06F 3/16

(52) U.S. Cl. CPC H04R 1/1041; G06F 3/165; H04R 2499/15

(57) ABSTRACT

This system comprises a digital signal processor able to apply processing operations to an audio signal to be reproduced, a tactile interface (130) displaying indications corresponding to a plurality of processing presets having predetermined processing parameters, and able to receive tactile controls for the continuous displacement of a processing adjustment cursor. The parameters to be applied to the digital signal processor are calculated as a function of the predetermined parameters of said presets and of the position of the adjustment cursor with respect to said different preset indication positions, to hence allow to apply a processing resulting from a combination of the presets in question. Application in particular to the making of multiple equalization settings, intuitively, for a listening headset.

The present invention generally relates to the audio systems, and more particularly the sound reproduction setting means of such systems, in particular the systems with a reproduction by an audio headset.

Certain headsets include a rechargeable battery and a wireless receiving circuit, for example radio (typically according to the Bluetooth specifications (registered trademark) or infrared), adapted to receive the audio signals conveyed by such a channel, in order to decode and transform them into analog sound signals applied to the transducers.

The most recent audio headsets also contain audio processing electronic circuits intended to perform an equalization, apply sound effects, dynamically control the volume of reproduction, neutralize the ambient noises, etc.

In some cases, the equalization and sound effect settings are selected from a list of presets, at the user's choice, through a control by means of an interface located on a remote device, such as a smart terminal or smartphone, communicating with the audio headset, typically through a wireless link according to the Bluetooth communication protocol. The headset marketed by the applicant company under the commercial name Zik (registered trademark) has such functionalities.

The US 2012/0063614 A1 and US 2014/0173519 A1 describe such interfaces for selecting and controlling different sound reproduction presets by suitable controls made available to the user.

The present invention aims to enrich the possibility of settings, in particular sound equalization settings, while allowing the user to perform such settings in a particularly simple and intuitive manner.

The invention hence proposes a sound reproduction system comprising, as disclosed in the above-mentioned US 2012/0063614 A1:
a digital signal processor able to apply processing operations to an audio signal to be reproduced according to parameters;
a touch-screen user interface adapted to display at predetermined positions indications corresponding to a plurality of processing presets having predetermined processing parameters, and to receive tactile controls for the continuous displacement of a processing adjustment cursor; and
means for calculating parameters to be applied to the digital signal processor as a function of the predetermined parameters of said presets and of the position of the adjustment cursor with respect to said different preset indication positions, to hence allow to apply a processing resulting from a combination of the presets in question.

Characteristically of the invention, the preset indications of this system are distributed into positions that are angularly offset two by two in an area having a shape of revolution. Moreover, the cursor is a single cursor, such that a displacement of this cursor in a radial direction with respect to the shape of revolution allows to adjust the intensity of the processing, whereas a displacement of this same cursor in a circumferential direction with respect to the shape of revolution allows to adjust the combination between the presets whose indications positions are the closest.

Some preferred but non limitative characteristics of this system, which can be taken in any combination estimated as technically possible by the one skilled in the art are the following:
the presets are frequency-band equalization presets;
the parameters of the presets comprise parameters of a band frequency filtering;
the parameters to be applied are calculated by interpolation as a function of the distance of the cursor with respect to two preset indication positions that are the closest of the cursor;
the system further comprises means for calculating the parameters to be applied to the digital signal processor as a function of the position of the cursor with respect to a reference position corresponding to the absence of processing and at least one closest preset indication position, to hence allow to adjust the processing intensity;
the system comprises a smart terminal comprising the user interface and the calculation means, and a listening headset comprising the digital signal processor; and/or
the system further comprises wireless communication means between the terminal and the headset, adapted to convey the audio flow and the parameters.

An exemplary embodiment of the invention will now be described, with reference to the appended drawings in which the same references denote identical or functionally similar elements throughout the figures.

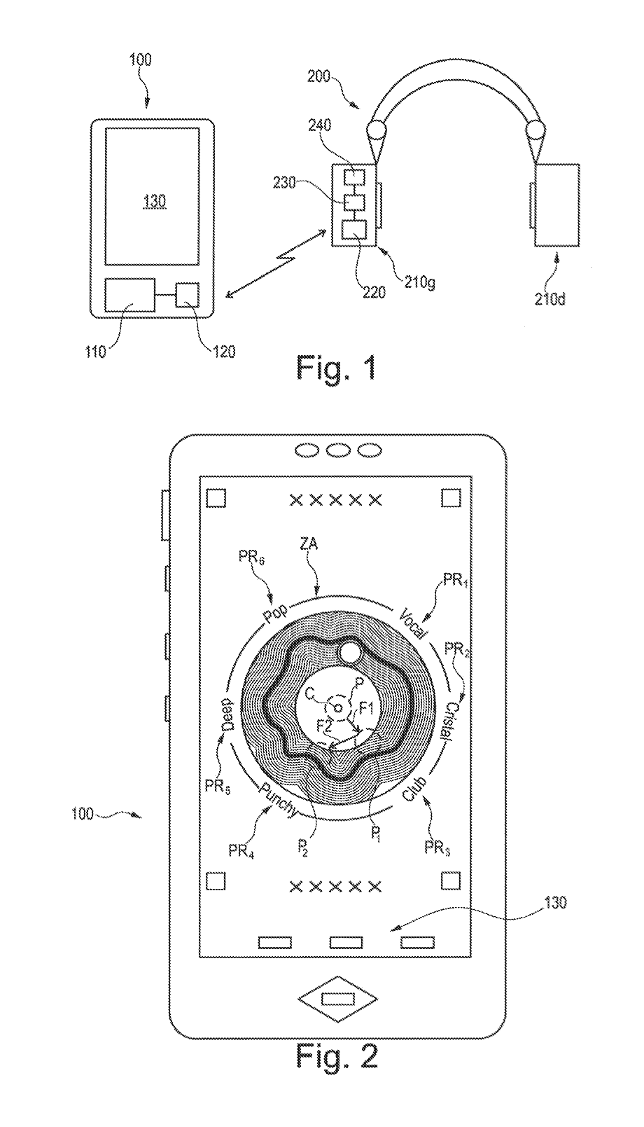

FIG. 1 schematically shows the different components of a sound restitution system for the implementation of the present invention.

FIG. 2 shows a preferred user interface for implementing the invention.

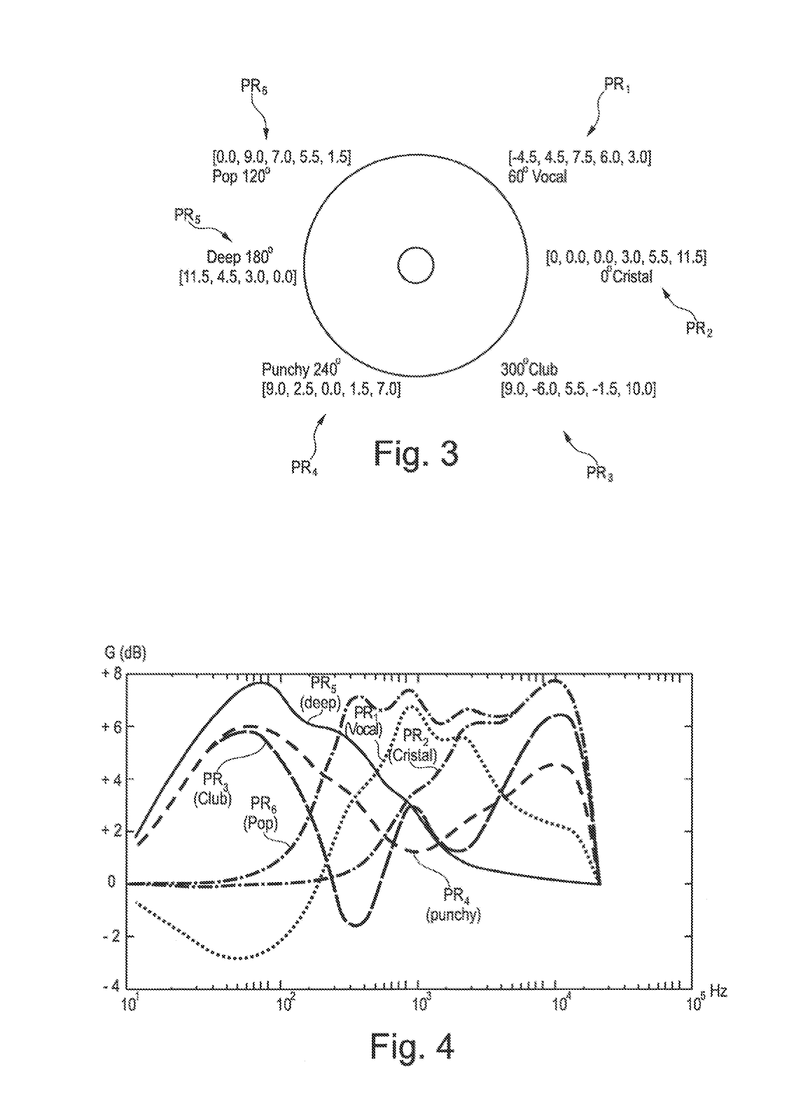

FIG. 3 shows equalization values corresponding to a set of presets that can be selected through the interface of FIG. 2.

FIG. 4 illustrates the response curves of the filtering operations corresponding to these equalizations.

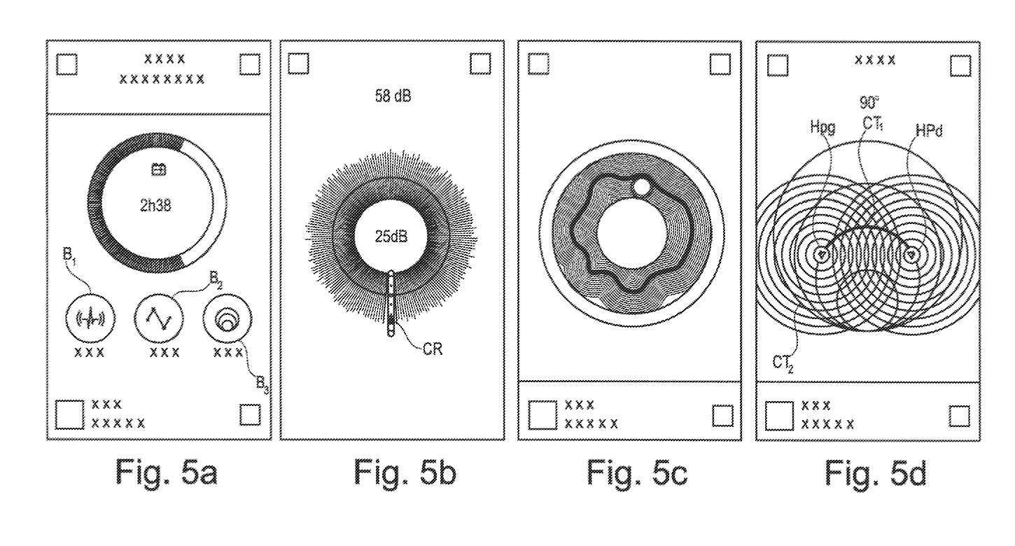

FIGS. 5a to 5d illustrate a set of user interfaces, among which that of FIG. 2, which can be used for the implementation of a set of functionalities linked to the sound reproduction.

First, with reference to FIG. 1, an audio listening system is shown, which comprises a user terminal 100 and an audio headset 200.

The terminal 100 is for example a smartphone and includes, in a manner known per se, a central processing unit and the conventional memory and input/output devices thereof, wireless communication means for example according to the WiFi and Bluetooth protocols, and a touch screen.

In FIG. 1 are simply illustrated the central processing unit 110, the Blue-tooth communication circuit 120 and the touch screen 130 of the terminal 100, with are of types known per se.

The headset 200, of the circumaural type, includes, in a manner conventional per se, two left and right earphones 210g and 210d, one of the earphones containing a Bluetooth receiving circuit 220 allowing it to communicate with the terminal 100, a digital signal processor 230 adapted to apply different types of processing (equalizations, reverberation, spatialization, etc.) to the sound flow received by the corresponding profile (typically the A2DP profile) of the Bluetooth protocol, and an amplifier 240 for the transducers contained in the left and right earphones.

An adapted profile of the Bluetooth protocol allows to transfer to the head-set 200, from the terminal 100, setting or parameter values to be applied to a control input of the digital signal processor 230 to modify the effects applied.

One of the effects that can be applied by the processor 230 is a frequency filter. For example, the processor implements an Infinite Impulse Response (IIR) filter characterized by a response based on the values of the signal applied at the input as well as the prior values of the response that this filter may have produced. It may in particular be an IIR filter of order 2, referred to as “biquad”, whose transfer function giving the output signal y at the instant n as a function of the input signal x at the instants n, n−1 and n−2 is given by:

y(n)=b₀*x(n)+b₁*x(n−1)+b₂*x(n−2)+a₁*y(n−1)+a₂*y(n−2)

the coefficients a₁, a₂, b₀, b₁, b₂ of the transfer function being derived from the parameters f₀, Q and G (central frequency of the processed band, band width or quality factor, and gain, respectively) of the filter.

The way these coefficients, or the parameters themselves, are adjusted in response to the setting choices performed by the user on the terminal, will now be described.

With reference to FIG. 2, a user interface according to a preferred example of the invention comprises, generated on the touch screen 130, a fixed area of revolution ZA, for example circular or annular, and herein generally annular, on which it is possible to displace, in response to a finger slide action thanks to the tactile input interface, a smaller setting curser, herein a circular setting chip P having a diameter substantially smaller than the outer diameter of the annular area ZA.

To well demarcate the position of the chip P with respect to the annular area ZA, the chip has a colour that contrasts sharply with that of the annular zone. For example, the chip P has a bright colour, whereas the area

ZA is shown in grey levels.

Six angular positions on the area ZA, mutually spaced apart by 60°, correspond to six frequency filtering presets. These six preset positions are denoted by the references PR₁ to PR₆, and each carry, on a peripheral circle of indicators CP, words or indicators evoking the settings, i.e. Vocal, Cristal, Club, Punchy, Deep and Pop.

Advantageously, and as illustrated, the annular area ZA has, in the circumferential direction, on its external edge and/or its internal edge, undulations that may be representative, for example, of certain filtering characteristics.

According to another preferred aspect, the internal and external edges of the annular area are not sharp edges, but blurred edges, with grey levels progressively shading towards the white when entering into the area and towards the black when exiting therefrom.

Characteristically of the invention, the displacement of the frequency filtering adjustment chip P allows to progressively vary the equalization.

A first degree of progressivity is obtained when, in response to the tactile interface, the chip P is displaced radially outward from the geometric centre C of the annular area ZA.

When this displacement is performed towards a given preset PRₙ (in FIG. 2, in the direction of the arrow F₁ towards the preset PR₃ Club, chip position P₁), then the central unit of the terminal 100 calculates, by interpolation between a zero intensity of equalization (no equalization effect) and a maximum intensity of equalization for this preset PR₃, the equalizazion parameters to be applied to the digital signal processor.

This interpolation is preferably performed by multiplying the gain parameters for each of the frequency bands (whether this gain is positive or negative), by a coefficient comprised between 0 and 1 and representative of the radial distance between the geometric centre C and the centre of the chip P when the searched position of said chip is reached (typically when the user removes his finger from the tactile input interface after having slid the chip to the desired position). This radial distance is determined with respect to a maximum radial distance, corresponding to the maximum intensity of effect, which is preferably located in the vicinity of the external edge of the annular area ZA.

A second degree of progressivity is obtained when, in response to the tactile interface, the chip P is displaced towards a position located between two presets PRₙ and PRₙ₊₁.

When such a displacement is performed (in FIG. 2, in the direction of the arrow F₂ towards the chip position P₂ located between the settings PR₃ and PR₄ Club and Punchy), whereas the central unit of the terminal 100 calculates, by interpolation between the values of equalization of the preset PR₃ and those of the preset PR₄, the equalization parameters to be applied to the digital signal processor.

This interpolation may be a linear interpolation based on the angular position of the chip P with respect to the angular positions, herein mutually spaced apart by 60°, of the two presets PR₃ and PR₄ surrounding the position P₂ of the chip.

It is understood that, in practice, the calculation of the parameters to be applied to the digital signal processor hence takes into account both the distance between the chip P and the geometric centre C and the angular position of said chip in the area ZA, the calculation combining i) a first interpolation between the parameters of two presets (except when the chip P is within a radius corresponding to a pure preset PRₙ) and ii) a second interpolation between a zero equalization and the parameters resulting from the first interpolation.

Once the chip brought, by means of the tactile interface, to the desired position, and staying still in this position, the parameters calculated as defined hereinabove are frozen and sent to the digital signal processor 230 of the headset 200. As a variant, and preferably, the parameters are calculated dynamically during the displacement of the chip P by means of the tactile interface and sent periodically to the processor 230 so that the user can listen to the effect of the so-adjusted processing on a sound flow in course of production.

Preferably, the presets are organised around the annular area ZA so that two angularly adjacent presets have similar parameters, so that an interpolation between the values of the adjacent preset parameters is musically meaningful.

In the present example, six presets are provided, whose parameter values are illustrated in FIG. 3. These parameters herein comprise a set of five preset values, which generally correspond (without entering into the details of implementation of the infinite impulse response “biquad” filtering) to gain values in five frequency bands, from the basses to the trebles.

It is observed that the “finest” equalization presets (rich in trebles and poor in basses, such as the Vocal and Cristal presets) are located in the annular area, at the opposite of the “deep” or “thick” presets such as Punchy and Deep, which are on the contrary rather rich in basses.

This allows to avoid in particular that an interpolation between the values of two presets risks to lead to a too neutral equalization. On the contrary, the musically closest settings (for example, the settings pairs Vocal/Cristal Punchy/Deep, etc.) are adjacent to each other, so that the interpolation is liable to give the best results.

FIG. 4 illustrates the frequency response curves obtained with the different parameters illustrated in FIG. 3. It is understood that, by interpolating between each other the parameters of two adjacent presets (chip angularly positioned between two presets), as well as by interpolating the parameters with those of a zero frequency-correction (chip positioned between the centre and the external peripheral area for which the correction is maximum), a very wide range of equalization presets can be obtained, and that in a particularly simple and intuitive manner for the user. In particular, the latter has not to know nor to manipulate (as in the prior art) values of band central frequency, quality factor and gain.

FIGS. 5a to 5d illustrate a set of user interfaces that can be implemented by a sound broadcast management application by an associated headset. FIG. 5a shows the main screen with, in the centre, a remaining duration of the battery supplying the headset, and, in the bottom, a set of buttons B₁, B₂ and B₃ allowing to reach the screens illustrated in FIGS. 5b a 5d. As an alternative, the passage from a screen to the other may be performed through a lateral slide by means of the finger thanks to the tactile interface.

FIG. 5b illustrates a screen of adjustment of the noise cancelling function equipping the headset 200.

In a manner known per se, a noise cancelling circuit of a headset has for object to cancel as precisely as possible, at the final reproduction by the transducers, the ambient noise. This circuit conventionally operates by picking up the ambient noise through a microphone integrated to the headset, and by superimposing to the sound flow to be reproduced a signal resulting from the inversion of the picked-up noise signal, with an amplitude corresponding to the attenuation of the noise by the pads of the headset. More sophisticated processing operations of course exist, but the objective is still to neutralize at best the ambient noise.

According to this aspect of the invention, of which the one skilled in the art will understand that it can be implemented fully independently of the above-described equalization setting function, the user may progressively set the degree of action of the noise reducer between a maximum action and a total deactivation, allowing on the contrary the listener to perceive the ambient sound environment. This allows to optimize the listening comfort as a function of the use. For example, when the headset is used as a handsfree device with a mobile phone (which is generally the terminal 100 itself), this system may let a certain portion of the ambient noise subsist to avoid a sensation of isolation, and also to allow the speaker to perceive more naturally its own voice.

FIG. 5b illustrates a cursor for setting the noise compensation CR, which allows to adjust for that purpose, in a continuous way or by stages, the ambient noise compensation, between a zero compensation value and a maximum compensation value, corresponding to the cancelling. The current value of the denoised sound level (“25 dB”) is displayed at the centre of the circle, over a radius (herein vertical) of which the cursor CR may be displaced with the finger of the user, the real level of ambient noise (“58 dB”) being displayed above this circle.

FIG. 5c corresponds to the above-described FIG. 2.

Finally, FIG. 5d illustrates a screen of setting of simulation of listening acoustic conditions (in particular, reverb type and width of the stereo-phonic image as a function of the listening place to be simulated).

A series of circles CT₁, CT₂, tangent to each other, illustrates the simulated size and/or the reverting or hushed character of the virtual listening place, whereas two symbols of loudspeakers HP_{g}, HP_{d} can be more or less spaced apart on the active circle by means of the tactile interface to selectively narrow or enlarge the stereophonic image.

Of course, the present invention is not limited to the embodiment and the variants described hereinabove, but the one skilled in the art will be able to make many adaptations thanks to his general knowledges. In particular:
the invention applies to the sound reproduction by any type of equipment, in particular circumaural or intra-auricular headset, set of loud-speakers, etc., with a wired or wireless link;
the equalization processing operations may be implemented by any type of circuit, digital or hybrid;
in the case of a system with a headset, the processing circuits may be provided in the headset as described hereinabove but, as a variant, in the user terminal broadcasting the sound flow;
the number and the arrangement of the presets may vary widely, just as the graphical representation of the areas in which their marks are located;
the user interface may vary widely, as a function of the type of device.

1. A sound reproduction system (100, 200), characterized in that it comprises:
a digital signal processor (230) able to apply processing operations to an audio signal to be reproduced according to parameters;
a touch-screen user interface (130) adapted to display at predetermined positions (PRₙ) indications corresponding to a plurality of processing presets having predetermined processing parameters, and to receive tactile controls for the continuous displacement of a processing adjustment cursor (P); and
means (110) for calculating parameters to be applied to the digital signal processor as a function of the predetermined parameters of said presets and of the position of the adjustment cursor with respect to said different preset indication positions, to hence allow to apply a processing resulting from a combination of the presets in question characterized in that:
the preset indications (PRₙ) are distributed into positions that are angularly offset two by two in an area having a shape of revolution (ZA);
the cursor (P) is a single cursor, such that:
a displacement of this cursor (P) in a radial direction with respect to the shape of revolution (ZA) allows to adjust the intensity of the processing, whereas
a displacement of this same cursor (P) in a circumferential direction with respect to the shape of revolution allows to adjust the combination between the presets whose positions of indication are the closest.

2. The system of claim 1, characterized in that the presets are frequency-band equalization presets.

3. The system of claim 2, characterized in that the parameters of the presets comprise parameters of a band frequency filtering.

4. The system of claim 1, characterized in that the parameters to be applied are calculated by interpolation as a function of the distance of the cursor with respect to two preset indication positions that are the closest of the cursor.

5. The system of claim 1, characterized in that it further comprises means (110) for calculating the parameters to be applied to the digital signal processor (230) as a function of the position of the cursor with respect to a reference position (C) corresponding to the absence of processing and at least one closest preset indication position (PRₙ), to hence allow to adjust the intensity of the processing.

6. The system of claim 1, characterized in that it comprises a smart terminal (100) comprising the user interface (130) and the calculation means (110), and a listening headset (200) comprising the digital signal processor (230).

7. The system of claim 6, characterized in that it further comprises wireless communication means (120, 220) between the terminal and the headset, adapted to convey the audio flow and said parameters.
